(19) United States
(12) Patent Application Publication
(10) Pub. No.: US 2009/0100295 A1
(43) Pub. Date: Apr. 16, 2009

(54) RELIABLE MEMORY MODULE TESTING AND MANUFACTURING METHOD

(75) Inventors: Siew S. HIEW, San Jose, CA (US); I-Kang YU, Palo Alto, CA (US); Abraham C. MA, Fremont, CA (US); Ming-Shiang SHEN, Taipei Hsien (TW)

Correspondence Address: Maryam Imam, 95 SOUTH MARKET STREET, SUITE 570, SAN JOSE, CA, 95113, US

(73) Assignee: SUPER TALENT ELECTRONICS, INC., San Jose, CA (US)

(21) Appl. No.: 12/339,001

(22) Filed: Dec. 18, 2008

Related U.S. Application Data
(63) Continuation-in-part of application No. 11/624,667, filed on Jan. 18, 2007.
Application No. 11/624,667 is a division of application No. 09/478,720, filed on Jan. 6, 2000, now Pat. No. 7,257,714.

(51) Int. Cl. G06F 11/263; G06F 11/26

(52) U.S. Cl. 714/29; 714/42; 714/27; 714/E11.168; 714/E11.177

(57) ABSTRACT

A method of testing memory modules comprising jumping through all addressable memory blocks a first and second time is disclosed. Each jumped-to address is determined by first XORing the last two bits of the previous address, and then XORing the first result with a bit representation of the previous jump direction for a second result. The second result determines the direction of the next jump, either upwards or downwards. Each jumped-to address is XORed with its contents, and the result is written to the address. For initially empty and defect-free memory, this results in all 1 values written for the first time jumping, and all 0 values written for the second time jumping. Finally, after the second time jumping, all addressable memory values are checked, and any non-0 value addresses are identified as defective memory cells.

### CROSS REFERENCE TO RELATED APPLICATIONS

This application is a continuation-in-part of U.S. patent application Ser. No. 11/624,667, titled “Electronic Data Storage Medium with Fingerprint Verification Capability,” filed Jan. 18, 2007, which is a divisional application of U.S. patent application Ser. No. 09/478,720, titled “Electronic Data Storage Medium With Fingerprint Verification Capability,” filed Jan. 6, 2000 and issued as U.S. Pat. No. 7,257,714.

### BACKGROUND OF THE INVENTION

1. Field of the Invention

The present invention relates to a method of manufacturing and testing DRAM memory modules. More specifically, the present invention relates to a method of manufacturing DRAM with reduced assembly and testing steps, and a method of testing whereby the memory modules are subjected to a intense and comprehensive read-write routine for the identification of otherwise latent memory cell defects.

2. Description of the Prior Art

Present memory modules, such as double data rate (DDR) dual inline memory modules (DIMMs), evolved from the late 1970s, when 8088 based PC motherboards used socketed dual inline package (DIP) chips. DIP chips were replaced by single inline pin package (SIPP) chips during the era of 286 based computing, which were then replaced by single inline memory (SIMM) package chips. Around the time that Intel's Pentium processors took over the computing market, DIMMs replaced SIMMs as the predominant type of memory.

Currently, DIMMs are available in a variety of form factors: slim outline (SO-DIMM), DDR-DIMM, double data rate 2 (DDR2-DIMM), DDR3-DIMM, un-buffered (UB-DIMM), fully buffered (FBDIMM), registered (RDIMM), and 100-pin DIMMs for use in printers.

Most consumer computers employ un-buffered DDR- or DDR2-DIMM memory. Regardless of the form used, the reliability and integrity of the data read/write functions to the memory are crucial to the computer's user. Sometimes, users may encounter unexpected intermittent memory errors. Screening out defects that cause these errors requires sophisticated test patters or additional environmental tests. This is especially true for DRAM chips.

Tested DRAM, available from most major DRAM suppliers, screens out gross and functionally defective chips, and yields populations of greater than 99% working memory. Suppliers charge extra for these tested parts, and cumulative costs for tested DRAM chips is expensive.

Major foundries, with good dies, are typically yielding 95% working chips from DRAM wafers. Suppliers offer these untested and packaged memory chips for a lower cost than the tested chips. The DRAM assembly process is well developed, and defects due to assembly errors are controlled—typically kept under a fraction of a percent in most assembly houses. Thus, module makers prefer to purchase untested DRAM chips at a significant cost savings, and “blind” build memory modules without pre-screen tests.

However, since a memory module typically consists of eight or more DRAM packaged chips mounted on a PCB substrate, this 95% yield translates into about 4 out of every 10 modules having a defective DRAM chip, and requiring a re-work to replace one or more DRAM chips. The percentage of defective modules requiring re-work increases as a higher count of packaged DRAM chips are mounted on the memory module substrates.

Regardless of this statistic, though, it is still more economical to rework, than to do a 100% DRAM chip pre-test to screen out defective parts, because the completed modules must be subjected to open, short, and march patterns at module level. Performing a pre-test would be redundant, and thus time-consuming and expensive.

FIG. 1 shows a flow chart 100 of a prior art method of manufacturing and testing memory modules. Of note in FIG. 1 are Initial DC Test of Packaged DRAMS from Fabrication step 103, and Full Functional Test on DRAMs After Burn-in step 109. Steps 103 and 109 are duplicative, requiring additional time and money for manufacturing, but are necessary due to the prior art manufacturing and testing methods.

What is needed is a more rapid memory module manufacturing and testing method, which removes unnecessary redundancy, but still reliably screens out both gross and latent defective parts.

### SUMMARY OF THE INVENTION

Briefly, an accelerated method of manufacture and an effective method of testing DRAM memory modules for gross and latent defects is disclosed. The method reduces testing time and costs associated with DC tests on packaged DRAM chips. Notably, the time expenditure associated with burn-in tests is removed, as well as the redundancy of testing individual DRAM chips and subsequently assembled memory modules. The disclosed testing method erratically moves through the entire range of memory, forcing all DRAM addresses to be accessed in an unpredictable sequence. The disclosed method's comprehensive DRAM access can be exploited to write known values with each pass, and then identify the cells with improper values as being defective. Consequently, in addition to detecting functional defects, less frequent behavioral defects, which arise when multiple memory modules work in concert, are also detected.

These and other objects and advantages of the present invention will no doubt become apparent to those skilled in the art after having read the following detailed description of the preferred embodiments illustrated in the several figures of the drawing.

### IN THE DRAWINGS

FIG. 1 shows a flowchart of a prior art method of manufacturing and testing memory modules.

FIG. 2 shows a flowchart of a method of memory module manufacturing and testing without a burn-in step, in an embodiment of the present invention.

FIG. 3 shows a flowchart of a method of memory module manufacturing and testing with burn-in, in an embodiment of the present invention.

FIG. 4 shows a motherboard memory module test setup.

FIG. 5a shows a buffered memory module.

FIG. 5b shows an unbuffered memory module.

FIG. 6a shows the input fields of a motherboard DIMM test.

FIG. 6b shows a flowchart of the jump direction calculation steps of the memory cell integrity emulation test.

FIG. 6c shows a flowchart of an alternative method of performing the jump direction calculation steps of the memory cell integrity emulation test.

FIG. 7 shows a stepwise progression through a simplified memory cell integrity emulation testing process.

FIG. 8a shows a flowchart of a host system probing a memory module prior to starting MCIE testing, and of a mapped memory space.

FIG. 8b shows a flowchart of a host system executing a memory cell integrity emulation test on memory modules.

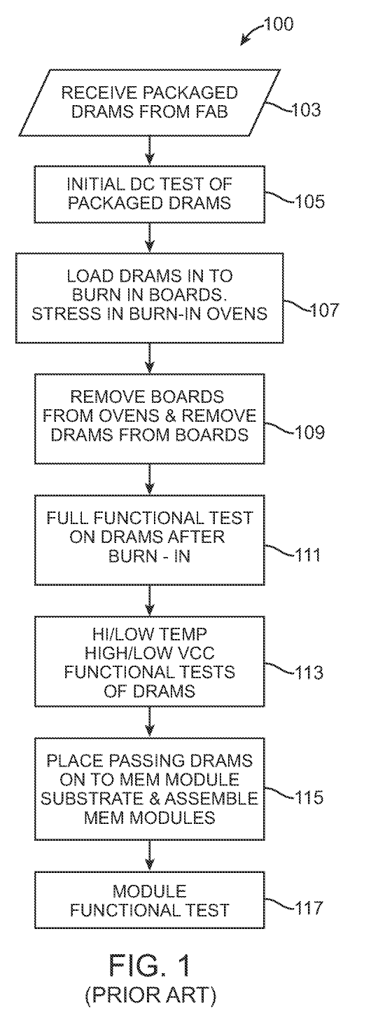

### DETAILED DESCRIPTION OF THE PREFERRED EMBODIMENTS

In the following description of the embodiments, reference is made to the accompanying drawings that form a part hereof, and in which is shown by way of illustration of the specific embodiments in which the invention may be practiced. It is to be understood that other embodiments may be utilized because structural changes may be made without departing from the scope of the present invention. It should be noted that the figures discussed herein are not drawn to scale and thicknesses of lines are not indicative of actual sizes.

In an embodiment of the present invention, a method of dual inline memory module (DIMM) manufacturing and testing is disclosed. The method has advantages over the prior art in that it reduces the testing steps necessary prior to module completion, and offers a more thorough means for testing the DIMMs for latent memory defects. Specifically, the redundancy in testing packaged DRAM of the prior art is eliminated, and the memory cell integrity emulation (MCIE) test of the present invention is a better representation of real world memory use, and identifies latent defects which would likely not be identified by prior art methods.

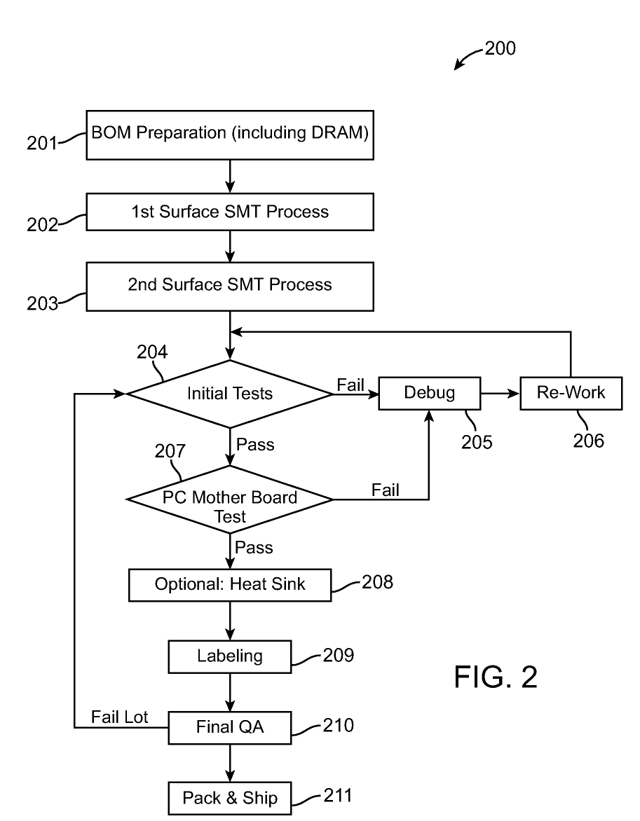

FIG. 2 shows flow chart 200 of a memory module manufacturing and testing method in accordance with an embodiment of the present invention. Flow 200 starts with Bill of Material (BOM) Preparation step 201, including the DRAM chips from the fabrication plant and printed circuit board (PCB) substrate. At step 201, all necessary raw materials, components, and fixtures for surface mount technology (SMT) manufacturing processes are staged.

At the First Surface SMT step 202, PCB substrate is loaded, printed with solder, components are picked and placed on the PCB substrate, and are then run through an re-flow soldering oven. After the first surface of the memory module's PCB substrate has cooled down and the components are fixed, the second surface of the PCB substrate may be further mounted with electronic components and again enter a re-flow soldering oven at step 203. The components placed on the second surface of the PCB substrate may be mounted in a pattern different than, or the same as, the pattern of the components of the first surface of the PCB substrate. The electronic components (DRAM chips, EEPROM, etc.) mounted to the PCB substrate are together referred to as a memory module. After the memory modules have completed re-flow the modules should be fully functional, unless there are defective DRAM chips, other defective components, or there are SMT induced defects (e.g. soldering shorts).

At step 204, the memory modules pass to initial test step 204. At step 204, the memory modules are subjected to simple tests that locate any significant or easily identified defects. These tests include, for example, open and short tests, to screen out gross electrical discontinuity or shorts before attempting pattern tests. Memory modules with electrical discontinuity or shorts may hang the hardware used for testing at PC motherboard test step 207, and thus must be identified and repaired prior to step 207. Pattern tests may also be done at initial test step 204 to filter out gross and marginally defective memory cell defects, and the memory module EEPROMs' may be programmed for serial presence detect (SPD) information.

Memory modules that fail initial test step 204 may be branched to debug step 205, as indicated in chart 200. At debug step 205, the defective memory modules are examined for physical evidence of open or short circuits that occurred during the SMT assembly process. If the defect is due to the wafer fabrication process, the defective DRAM chip is identified, and the marked to be removed.

At re-work step 206, any DRAM chips that have been identified and marked as defective are de-soldered and removed from the PCB substrate; and are then replaced with a new DRAM chip. The replacement DRAM chips used in re-work step 206 may be previously tested chips, and thus known to be working, or may be untested DRAM chips directly from fabrication. Memory modules that have been re-worked at re-work step 206 are then sent back into initial test step 204 for a re-test, ensuring that all memory modules meet the same quality standards.

Although the memory tests utilized at Initial Test step 204 are capable of identifying most of the defective chips, a percentage of chips that pass the tests of step 204 will fail under typical computing use. Therefore, all modules that pass initial test step 204 proceed to PC motherboard test step 207 for additional and more rigorous testing.

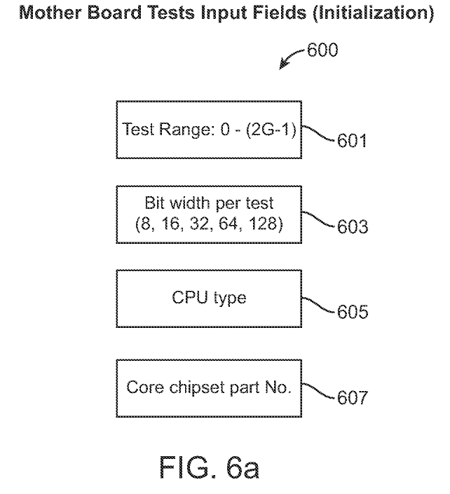

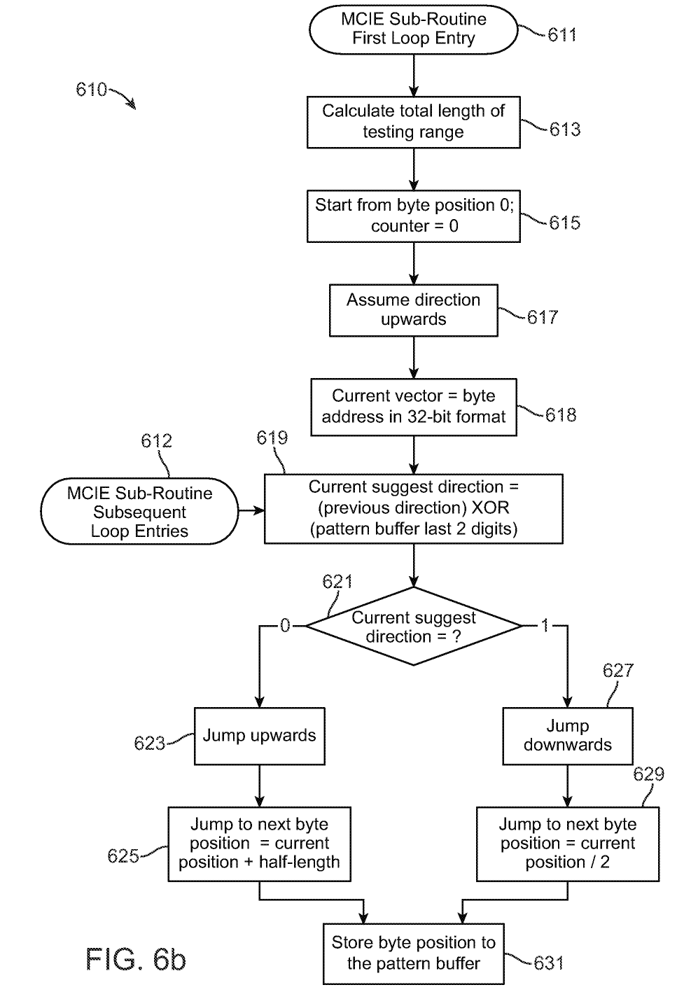

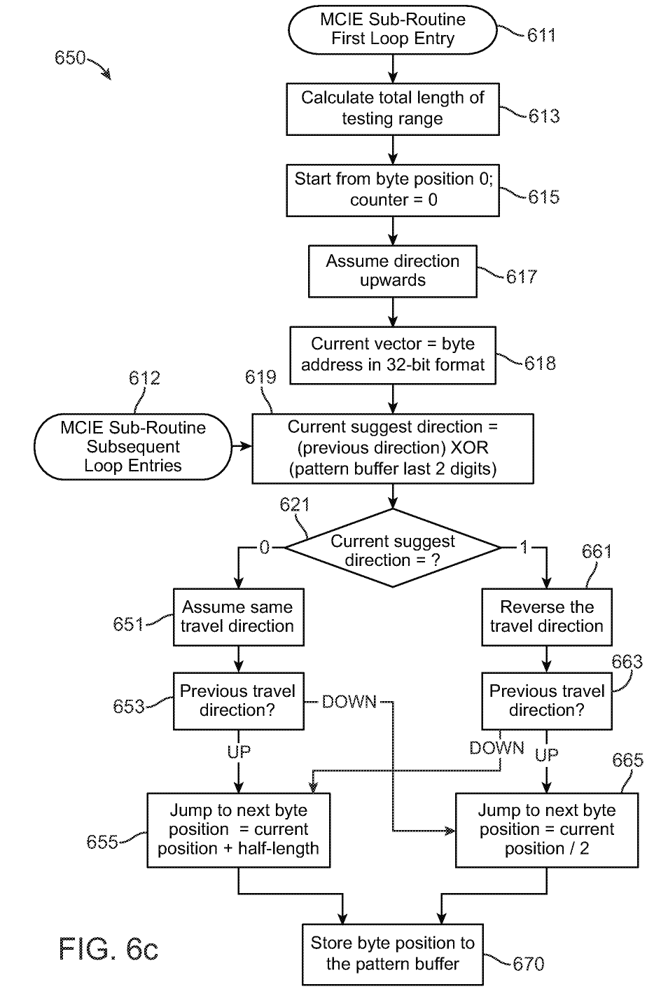

At PC motherboard test step 207 the memory modules are subjected to pattern tests on a PC motherboard. The test steps of at step 207 may include pattern tests, such as bit stuck and checkerboard tests; as well as address tests, such as cross-talk tests and memory cell integrity emulation (MCIE) tests. These tests may detect DRAM chips containing stuck cells (both high and low), cells with poor isolation, cells with low level parasitic trap charges in gate oxide, and cells that may cross talk at high clock rate. Further tests may include moving inversion, block move, modulo, and other tests capable of filtering out DRAM with marginal or intermittent defects. The MCIE test is discussed in more detail below, in reference to FIGS. 6a through 8b.

After the PC motherboard test step 207, any memory modules that are found to expend excessive amounts of heat, such as extremely fast DDR memory modules, may have heat sinks affixed at optional heat sink step 208. Heat sinks are generally fabricated out of solid piece of metal, for example aluminum, and interface tightly with all the DRAM chips sharing a PCB substrate surface of the memory module. The heat sinks conduct heat energy away from the DRAM chips, and provide significantly more surface area for heat dissipation, thus increasing the life and reliability of high performance memory modules. Heat sinks may be affixed to one or both sides of DRAM chips on the memory module. Exemplary candidates for heat sink attachment are fully buffered DRAM DIMMs.

From optional heat sink step 208, the memory modules continue to where they can be labeled, and then to final quality assurance step 210. At final quality assurance step 210, any modules with physical blemishes or previously unnoticed physical defects fail out and return to the initial test step 204. Memory modules that pass final quality assurance step 210 are packed and shipped to vendors, consumers, and other customers.

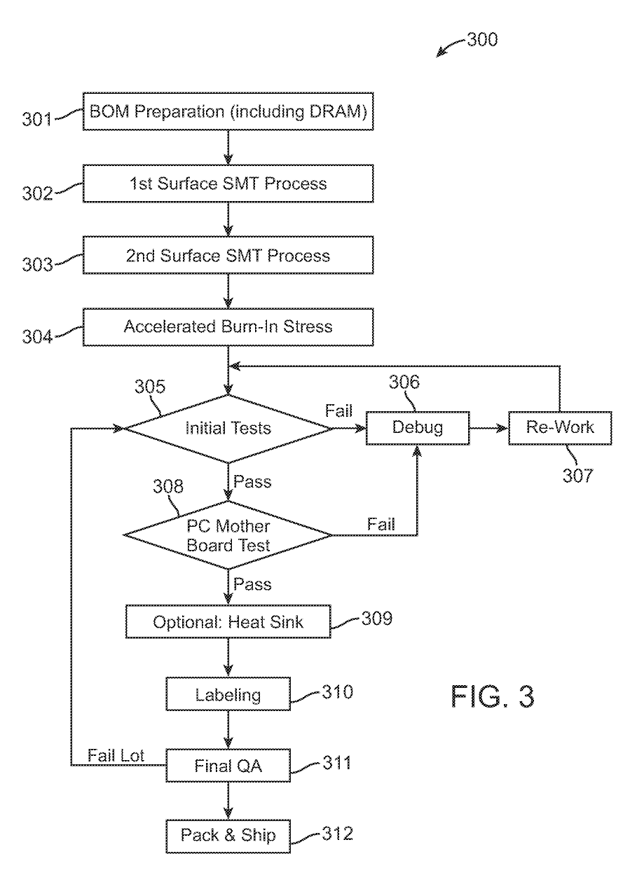

As shown in FIG. 3, the manufacturing and testing flow of FIG. 2, may include an additional step. In manufacturing and testing flowchart 300 of FIG. 3, accelerated burn-in stress step 304 is found in between the second PCB surface SMT mounting and soldering re-flow test step 303, and the initial tests step 305. At accelerated burn-in stress step 304 DRAM chips are subjected to temperature, voltage, and other physical stresses which induce an early mortality in chips containing manufacturing defects. Extensive and elaborate burn-in processing is not necessary, as tests of the PC Motherboard Test steps 207 and 308 will identify greater than 99% of all electrically detectable defects.

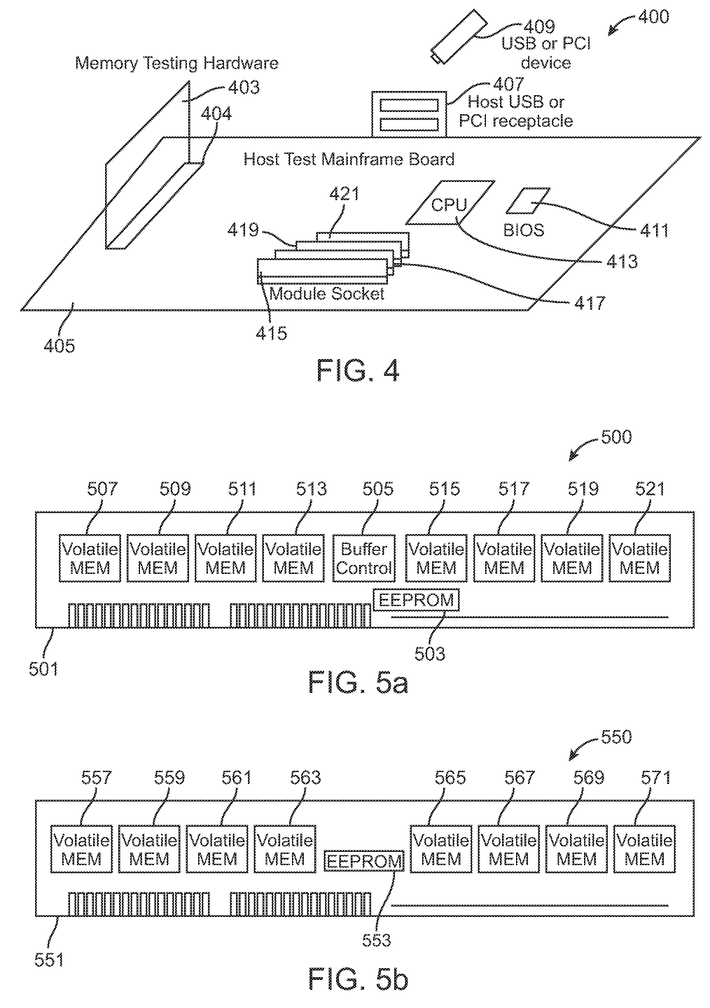

Referring now to FIG. 4, motherboard test setup 400 is shown. A host motherboard 405 is shown coupled to memory testing hardware 403 and/or 409. The host motherboard 405 includes a CPU 413, basic input/output system (BIOS) chipset 411, memory testing hardware receptacle 404 and/or 407, and memory module sockets, to which memory modules 415-421 are coupled, in one embodiment of the present invention. Memory testing hardware receptacles 404 and 407 are interfaces on the motherboard for connecting peripheral cards and devices. In one embodiment of the present invention, memory testing hardware receptacle 404 is a PCI slot. Memory testing hardware 403 is inserted into memory testing hardware receptacle 404, and is, for example, a PCI card. Memory testing hardware receptacle 407 is a female USB socket in accordance with one embodiment of the present invention. In such an embodiment, memory testing hardware 409 is a peripheral device having a male USB plug.

Memory testing hardware 403 and 409 contain program code for execution by CPU 413. Executing the code, CPU 413 accesses system memory, and performs a variety of intense memory testing patterns. Of specific interest is the MCIE test, which is discussed below.

As shown, in FIG. 4, the motherboard 405 of motherboard test setup 400 includes four memory module sockets for memory modules 415-421. In other embodiments of the present invention, the motherboard 405 may include less (e.g. two) or more memory module sockets (e.g. six, eight, or ten). The present invention is also contemplated in other embodiments having significantly different test hardware. These embodiments might involve a “dummy” motherboard having no CPU and/or BIOS; the motherboard serving only to connect memory module sockets with the memory testing hardware, and the memory testing hardware having the CPU functionality on-board, for executing the MCIE testing. Similarly, the motherboard might have the test hardware integrated, and having only memory module sockets. In such an embodiment, additional testing hardware would not be necessary, as the MCIE testing algorithm resides on the motherboard's components and not on peripherally attached devices.

FIGS. 5a and 5b show memory modules 500 and 550, respectively. Memory module 500 comprises PCB substrate 501, to which EEPROM 503, buffer control 505, and volatile memory chips 507-521 are coupled. Volatile memory chips 507-521 are DRAM chips in one embodiment of the present invention. Memory module 500 is shown comprising eight volatile memory chips, or DRAM chips, 507-521. In other embodiments memory module 500 may include less, or more, DRAM chips mounted on a single surface of the PCB substrate. On the other side of module 500 is a second PCB substrate surface, which may have additional volatile memory chips mounted thereupon.

Memory module 550 comprises EEPROM 553 and volatile memory chips 557-571. Memory module 550 is substantially the same as memory module 500, except that it lacks a buffer control, and thus is an unbuffered memory module.

EEPROMs 503 and 553 contain identifying information, for example serial presence detect (SPD), which is used by the memory testing hardware 403 or 409, and CPU 413 of FIG. 4 to count and identify the present memory modules. If the memory modules inserted in the motherboard do not share similar qualities, e.g. capacity and speed, then the motherboard testing may abort. The presence of memory modules in all motherboard memory module sockets enables dual channel access, and thus more rapid testing of the memory modules.

FIG. 6a shows input fields that may be used to initialize the PC motherboard testing process in one embodiment of the present invention. Input fields 600 include test range 601, bit width 603, CPU type 605, and core chipset part number 607. Test range 601 is the capacity of the memory to be tested, e.g. 1 GB, 2 GB, or 4 GB. Test range 601 is necessary for proper implementation of the MCIE testing. MCIE testing requires execution of a unique algorithm depending upon the combined memory module capacity. Without an assessment of the test range, the MCIE test would not assure thorough testing of the memory modules, and defective memory cells may slip through the quality assurance process.

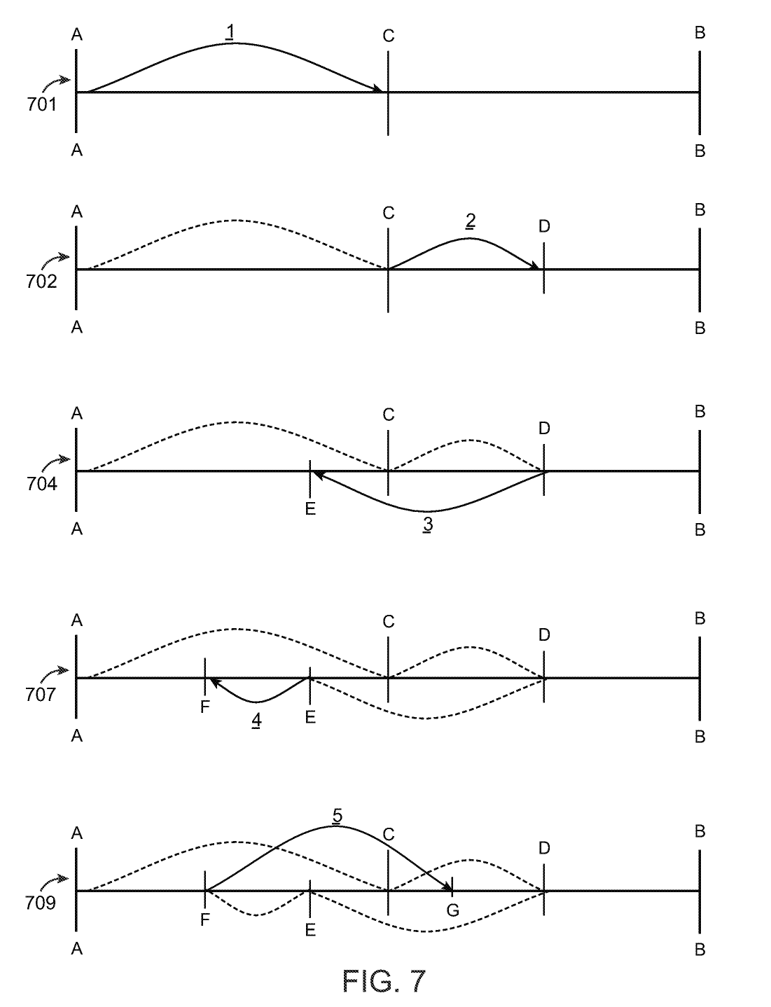

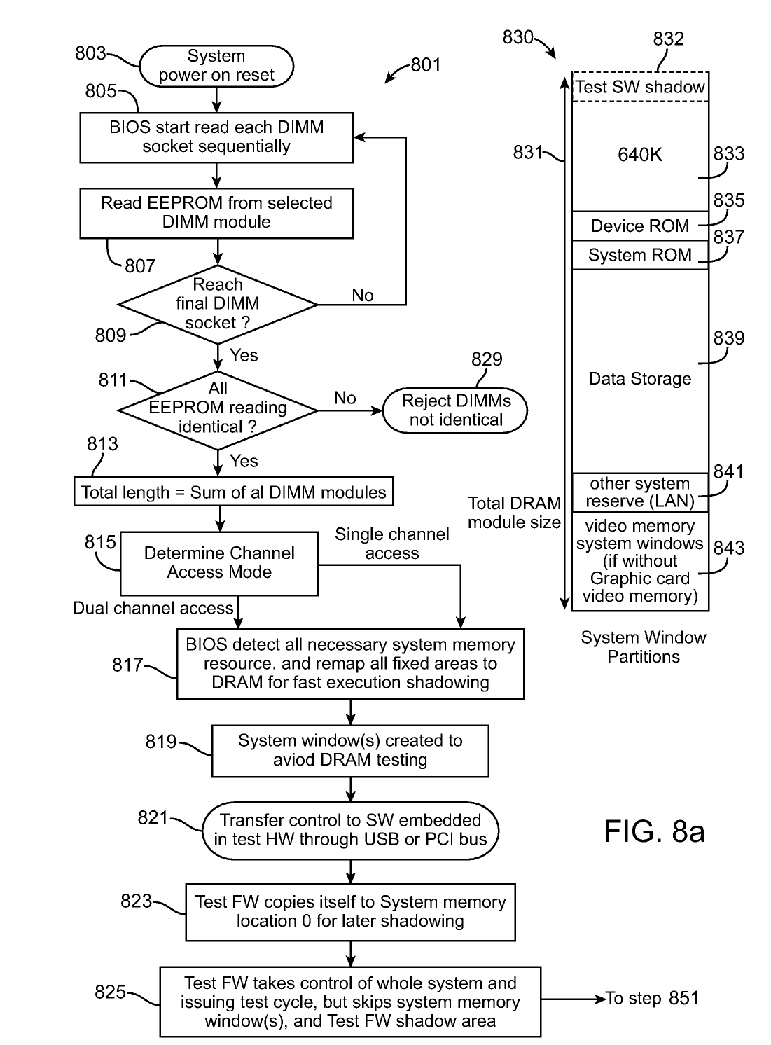

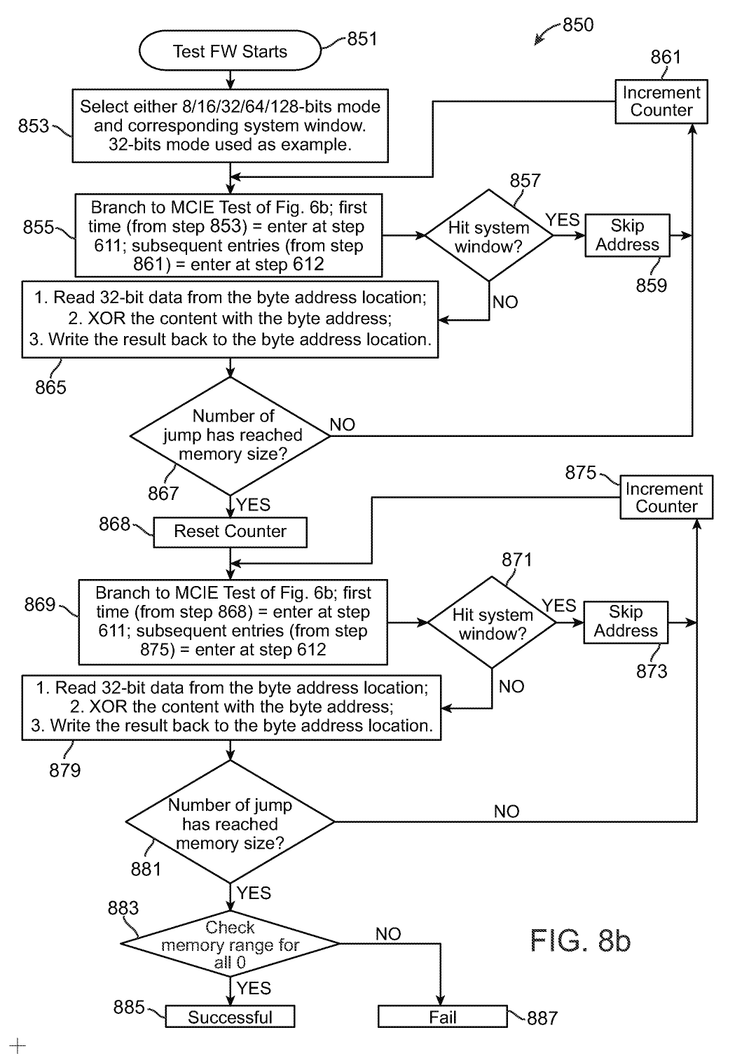

The MCIE test algorithm factors in bit width 603 to guide its progression through the memory testing range. As will be explored in FIGS. 7-8b, the MCIE testing algorithm jumps rapidly and randomly throughout the memory testing range. With each jump, the MCIE testing algorithm must ensure that it does not attempt to address a reserved memory location, or attempt to address a location where, because of the bit width or block size, previously written MCIE test bits will be changed.

CPU type 605 of the test system may be noted for every lot of tested memory modules. Information regarding CPU type 605 helps to identify the CPUs which are not compatible with the tested memory modules in a particular computer. This may help track problems when memory modules are returned from customers.

Core chipset part number 607 of the test system may also be noted for every lot of tested memory modules. Similar to CPU type 605, tracking the compatibility of tested memory modules with specific computers may help track problems in the memory modules returned from customers.

Referring now to FIG. 6b, flowchart 610 shows the direction suggest portion of the MCIE test algorithm in accordance with one embodiment of the present invention. The MCIE test algorithm may start at MCIE sub-routine entry 611 or 612. Entry 611 is used as the start position when calculating the first jump for testing a given memory space, i.e., the MCIE testing algorithm is at byte position 0. Entry step 612 is used when determining the movement direction for all subsequent jumps, and will be discussed further in reference to FIG. 8b. The first step of the MCIE test algorithm is calculating the length of the testing range at step 613. The testing range is generally all of the memory addresses of the memory modules inserted into the system motherboard, spanning from address 0 to the final addressable memory cell. This range is reduced to account for software shadow space and system reserve (system window) space, which is discussed in more detail below, in reference to FIG. 8a.

All MCIE tests begin from byte position 0, as shown at step 615. In one embodiment of the present invention, as discussed below in more detail below, the MCIE test software may shadow itself into a small portion of the memory being tested. In such embodiments, the test software will be located starting from hardware address 0, and byte position 0 for testing will actually represent a later address—the next address free following the test software shadow. In other embodiments of the present invention, the test software may reside in other memory, and hardware address 0 will also be byte position 0.

From byte position 0, the MCIE testing algorithm must assume a movement upwards, or into the range of memory addresses, as shown at step 617. Discussed in more detail in reference to FIG. 7, the MCIE testing algorithm is actually inherently forced to move to the middle memory address with its first jump.

At step 618, the current vector is set to the current byte address in 32-bit format. In the case where this is the first time to run through an MCIE test loop, the current vector/current address is going to be address 0.

At step 619, a bit value representing the current suggested direction is calculated. The current suggested direction is calculated by taking the previous direction's bit representation (0 or 1) and performing an XOR operation against the last two digits found in the pattern buffer. In one embodiment of the present invention, a previous upward jump direction is represented by a 0 value, and a previous downwards jump direction is represented by a 1. The last two digits within the pattern buffer are also represented by only 0s or 1s, and thus the last two digits of the pattern buffer, at any time, will always be either 00, 01, 10, or 11. Performing an XOR of the pattern buffer's XOR result to the previous direction's bit representation will result in one of two binary values, either a 0 or a 1. At step 621, the MCIE testing algorithm determines what the result is. If the result is a 0, then the direction suggest algorithm proceeds to step 623; and if it's a 1, then the direction suggest algorithm proceeds to step 627.

At step 623, the direction suggest algorithm determines that the next travel direction will be upward, and proceeds to step 625 where the next jump occurs. At step 625 the next byte position is jumped to. The next byte position may be calculated as the current byte position summed with half of its length. In such instances, the next byte position is equal to one-half of the distance from the current byte position to the final byte address. For example, jumping forward in base-ten representation, if the current address is 32 out of 256, then there are 224 address to the final address, and the new jumped to position is (224/2)+32, or 144. After the jump, the MCIE direction suggest algorithm stores the new byte position to the pattern buffer, at step 631.

The pattern buffer is a reserved memory region for storing memory addresses. The pattern buffer is used to lookup the previously jumped-to address, and for calculating the next address to jump to. The pattern buffer's size depends upon the memory being tested. If the tested memory is addressable via 32-bits, then the pattern buffer must be at least 32-bits in size; similarly, if the tested memory is addressable via 64-bits, then the pattern buffer must be at least 64-bits in size. In one embodiment in accordance with the present invention, the pattern buffer is not appended with each write, but instead is continuously re-written, being written to each time the MCIE testing algorithm reaches step 631, i.e., with each jump through the tested memory. In other embodiments of the present invention, the pattern buffer may not have the entire jumped-to address written, for example, just the least significant bits, and/or may be appended to, instead of re-written, with each jump.

Returning to FIG. 6b, if instead of 0, the current suggest direction result is 1 at step 621, then step 627 is next, instead of 623. At step 627 it is determined that the travel direction downwards, and the MCIE test software proceeds to step 629 for the jump. At step 629, the next byte position is jumped to. The jumped to next byte position may be calculated as being the current byte position divided by two. For example, jumping backwards in base-ten representation, if the current address is 128 out of 256, then half the distance, and the new jumped to position is (128/2), or 64. After the jump, the MCIE direction suggest algorithm stores the new byte position to the pattern buffer, at step 631.

As will be discussed in reference to FIG. 8b, the steps of direction suggest flowchart 610 shown in FIG. 6b are a sub-routine of the MCIE test, for the limited purpose of calculating the next jump direction, and then jumping to it. The MCIE sub-routine for calculating jump direction of flowchart 610 may be entered into at either step 611 or 612. The entry step depends on the state of the MCIE test, or more precisely, which iteration of the MCIE test, and will be discussed in reference to FIG. 8b. After jumping at steps 625 or 629, and storing the new byte position to the pattern buffer at step 631, the sub-routine exits and returns to the MCIE test. After returning to the MCIE test, the new address is written to, and additional jumps and writes will follow until all of the memory range has been written.

Referring to FIG. 6c, flowchart 650 shows an alternative direction suggest portion of the MCIE test algorithm, in accordance with an alternative embodiment of the present invention. Steps 611-621 of flowchart 650 of FIG. 6c are identical to steps 611-621 of flowchart 610 of FIG. 6b. In the direction calculation method of flowchart 610, an XOR result of 0 at step 619 always results in a jump upwards at steps 623-625, while an XOR result of 1 at step 619 always results in a jump downwards at steps 627-629. In the alternative direction calculation method of flowchart 650, the XOR results (0 or 1) are not statically linked to a direction (i.e., upwards or downwards).

Instead, in the calculation method of flowchart 650, the XOR result represents that the next jump will be in either the same direction or the opposite direction of the previous jump. Therefore, a final XOR result of 1 may cause jumps upwards and downwards, and, similarly, a final XOR result of 0 may cause jumps upwards and downwards as well.

At step 621 of FIG. 6c, if the current suggest direction is a 0 bit value, then the same travel direction is assumed for the next jump (same as the travel direction of the previous jump), at step 651. At step 653, the previous travel direction is determined. If the previous travel direction was upwards (towards the end of the memory addresses), then the MCIE test software jumps upwards, again, to the next byte position. If the previous travel direction was downwards (towards the first memory address), then the MCIE test software jumps downwards, again, to the next byte position. If jumping upwards from step 653, the next byte position is calculated at step 655, which may be calculated as the current position+half length. If jumping downwards from step 653, the next byte position is calculated at step 665 which may be calculated as the current position divided by two. After jumping to the next byte position at steps 655 and 665, the new byte position is stored to the address buffer at step 670, which is substantially identical to the storing byte position to pattern buffer step 631, as discussed above, in reference to FIG. 6b.

At step 621 of FIG. 6c, if the current suggest direction is a 1 bit value, then the travel direction for the next jump is reversed (opposite of the travel direction of the previous jump), at step 661. At step 663, the previous travel direction is determined. If the previous travel direction was upwards (towards the end of the memory addresses), then the MCIE test software jumps downwards to the next byte position. If the previous travel direction was downwards (towards the first memory address), then the MCIE test software jumps upwards to the next byte position. If jumping upwards from step 663, then the previous jump direction was downwards, and the next byte position is calculated at step 655, which may be calculated as the current position+half length. If jumping downwards from step 663, then the previous jump direction was upwards, and the next byte position is calculated at step 665, which may be calculated as the current position divided by two. After jumping to the next byte position at steps 655 and 665, the new byte position is stored to the address buffer at step 670, which is substantially identical to the storing byte position to pattern buffer step 631, as discussed above, in reference to FIG. 6b.

As will be discussed in reference to FIG. 8b, the steps of direction suggest flowchart 650 shown in FIG. 6c are a sub-routine of the MCIE test, for the limited purpose of calculating the next jump direction, and then jumping to it. The MCIE sub-routine for calculating jump direction of flowchart 650 may be entered into at either step 611 or 612. The entry step depends on the state of the MCIE test, or more precisely, which iteration of the MCIE test. This will be discussed further in reference to FIG. 8b. After jumping at steps 655 or 665, and storing the new byte position to the pattern buffer at step 670, the sub-routine exits and returns to the MCIE test.

The first and second bit values (0 and 1) are not universally statically linked to maintaining and reversing directions (respectively). In other embodiments in accordance with the present invention, a bit value of 0 may cause the direction suggest algorithm to reverse the jumping direction, and a bit value of 1 may cause the direction suggest algorithm to assume the same travel direction.

Referring now to FIG. 7, a simplified jump diagram is shown, to help illustrate the MCIE test algorithm flowchart of FIG. 6b, in one embodiment of the present invention. The memory addressing system begins at the byte position zero (B0) position, which is represented by location A in FIG. 7. When starting at byte position 0 (A), the MCIE testing algorithm assumes a direction of upwards, towards the final byte address. The final byte address is represented by B in FIG. 7. The final byte address depends on the size of the memory modules inserted into the PC host motherboard, with large memory ranges having larger final byte addresses. All jumps within the MCIE algorithm are based on the distance from the present byte address to either the address of either byte position 0 (or ‘A’), or the final byte address (‘B’). Further, each jump, regardless of the jump starting position, covers half of the distance from the jump's initial byte address, to either B0 (A) or the final byte address (B). For example, in base-ten representation, if starting at address 128 out of 256, then the next jumped to position will be either 64 (half the distance to 0), or 192 (half the distance to 256).

At initial jump step 701 of FIG. 7, the MCIE testing algorithm is jumping from the starting position A, and therefore must jump upwards, towards B. Because each jump must occur at half a distance, jump 1 of the MCIE testing algorithm jumps to C, which is half-way between A and B. The first jump of every MCIE testing algorithm is essentially forced, and will always land halfway between the first and last addressable memory cells. If the total memory range is 2 GB, then the position C will be at the 1 GB memory address. Similarly, if the total memory range is 4 GB, then the position C will be at the 2 GB memory address.

At jump step 702, the MCIE testing algorithm is capable of jumping down, towards address A, or upwards again, towards address B.

The direction of the next jump is determined by taking the XOR of the last two bits of the current address (taken from the address buffer, as discussed relative to FIG. 6b), and then XORing the result with a single-digit binary representation of the previous move. If the previous movement was in the forward direction, the value used is 0, and if the previous move was in the reverse or backwards direction, the value used is 1. If the result of the XOR operation is 0, the MCIE algorithm moves forward; and if the result of the XOR operation is 1, the MCIE algorithm moves in the backwards direction. In alternative embodiments of the present invention, a 0 value may cause the MCIE algorithm to move in the reverse direction, while a 1 value may cause the MCIE algorithm to move forward. Further, a 1 value may be used to represent forward direction movement, and a 0 value may be used to represent movement in the backwards direction in alternative embodiments in accordance with the present invention.

This XOR calculation occurs for each individual jump. For example, in FIG. 7, an XOR operation would be used to calculate the direction of the next move in each of the jumps (jump steps 702, 704, 707, 709). For moving forwards, the next byte position may be calculated as being the current position+half of the calculated memory length. For moving backwards, the next byte position may be calculated as being the current position divided by two.

In jump step 702 as shown, the MCIE testing algorithm determines to jump upwards again, towards address B a second time. With jump 2, the MCIE algorithm lands at address D, which is halfway between address C and address B. Because address C is centered between addresses A and B, the second jump of any MCIE testing algorithm must inherently travel only half the distance of the previous jump.

From address D, the MCIE testing algorithm must determine whether it should jump upwards again towards address B, or jump downwards. At jump step 704, the MCIE testing algorithm has determined that it will jump down, towards address A. While not shown, the MCIE testing algorithm has determined direction of jump 3 by taking the XOR of the last two bits of the current address (last two bits of D), and then XORing the result with a single-digit binary representation of the previous move (from C to D the jump was forward, represented by a 0). Because the MCIE testing algorithm has reversed its prior direction (now jumping backwards, rather than forwards), the result of the XOR operation was a 1 (e.g., step 621 of FIG. 6b or 6c). With jump 3, the MCIE testing algorithm jumps to address E, which is located halfway between previous address D and byte position 0 (A).

In jump step 707, the MCIE testing algorithm jumps downwards, towards address A, a second time in a row. While not shown, from E, the MCIE algorithm determined whether to maintain its previous backwards jump direction, or to jump upwards. The direction of jump 4, was determined by taking the XOR of the last two bits of the current address (E), and then XORing the result with a single-digit binary representation of the previous move (a 1). For jump 4, the MCIE testing algorithm has jumped backwards again, so the XOR result was a 1. After deciding direction, the MCIE testing algorithm jumps to address F, which is located halfway between previous address E and byte position 0 (A).

In final jump step 709, jump 5, the MCIE testing algorithm jumps upwards, towards address B. With jump 5, the MCIE testing algorithm jumps to address G, which is located halfway between previous address F, and final address B.

Jumping in this manner, through the available memory space, forces the computer to access the DRAM in an erratic and taxing manner rather than by moving sequentially through memory. The MCIE algorithm ensures that all memory space will be touched exactly once each time the algorithm is executed to completion.

Each time the MCIE test arrives at an address, it XORs the contents of the address with the address itself. In a properly operating memory module, therefore, all memory cells will hold a value of 1 after the first time the MCIE test runs to completion. When the MCIE test is run a second time, and again with each jump the test XORs the jumped-to address with the contents of the address, all memory cell values will be 0 upon completion in defect-free memory modules.

After the second MCIE testing algorithm has accessed the entire memory testing range, if any blocks (e.g., 8, 16, 32-bit blocks, depending on the test size determined at initiation) are not completely 0, then there are stuck or problematic bits within that block. A memory cell stuck in either the low or high position will affect the values of other bits within the block in either the first or second XOR computation. For example, a memory cell stuck in the high, or 1, position may first cause problems when expectedly all 0s are XORed with the starting address of the block which the stuck memory cell is within, and may again cause problems in the final reading, when all 0s are expected. A memory cell stuck in the 0 position may cause erroneous values to be re-written to its block when what should be all 1s (in a properly functioning memory module) is XORed to the address.

Providing the memory module is defect-free, the correct final value of each memory cell is known for each time the MCIE algorithm runs to completion. Any incorrect final memory cell values make the DRAM chips with defects readily apparent, as these incorrect bits inherently indicate the physical location of the defective cell(s). Such identification facilitates the quick removal and replacement of faulty DRAM chips, and then re-injection of the memory module into the manufacturing and testing process.

Referring now to FIG. 8a, a flowchart 801 of a host system probing a memory module prior to starting MCIE testing, mapping the memory space, and initiating testing. At step 803 the host system is powered on (e.g., the power button is pressed by a human operator), and at step 805 the BIOS begins to read each inserted memory module socket. More specifically, with the initial power-on, the BIOS reads the first memory module. As noted above, the BIOS must ensure that all inserted memory modules are the same size and type. Proper identification of the memory modules is assisted by also reading the EEPROM of the first memory module at step 807. After each memory module EEPROM is read, the host system checks to see if it has read the final memory module socket. If, for example, there are four memory sockets, each containing an inserted memory module, then the EEPROM of each inserted memory module must be read—going through step 807 four times. After the EEPROM is read, then at step 809 the host system determines whether the final memory module has been read. In the present case, if only the first memory module EEPROM has been read, then the final memory module socket has not been reached, and the host system returns to step 805 to identify the next memory module.

After all memory modules have been read, the host system proceeds to step 811 for verification that all readings are identical. If the EEPROMs indicate that the inserted memory modules are different (not identical), then the host system aborts at step 829. However, if the EEPROMs indicate that the inserted memory modules are identical, then the host system calculates the total length of memory space at step 813. Calculating the total length of the memory spaces may involve summing up all of the available space of all inserted memory modules, minus shadow and reserve space, which will be discussed shortly.

After the total length of the memory space has been calculated at step 813, the host system proceeds to step 815, where the host system detects whether the memory modules are configured for dual channel or single channel. Dual channel access enables access of neighboring blocks for faster block reading and writing, whereas single channel access (or sequential channel access), requires sequential channels be treated as blocks for reading and writing. Dual channel access is substantially faster for performing read and write operations than single channel access, and thus is the preferred method of performing MCIE testing.

After the channel setting has been established at step 815, the host system BIOS detects all the necessary system memory resources, and remaps the fixed areas to DRAM for fast execution shadowing at step 817. In an embodiment in accordance with the present invention, the BIOS is used to detect external memory devices, which are attached to the testing system, and remap the content of these memory devices into predetermined regions of the attached memory modules. These regions are known as system windows.

At step 819, system windows are created. System window are addresses located within the combined memory modules address range that are inaccessible to the MCIE test. These addresses are not actually locations on the DRAM chips or memory modules, but are instead I/O for addressing system devices, such as network ports and video memory. Because the MCIE test is only for testing the integrity of DRAM chips, MCIE access to these areas is, at the best, unnecessary, and at the worst, problematic. The MCIE test software will use any system windows created by the host system.

At step 821, the host system transfers control to the hardware device which the MCIE testing software resides on. From here, the CPU is no longer controlled by the BIOS, but is instead controlled by the MCIE testing software. As noted above, relative to FIG. 4, this hardware device may be a PCI card or a USB device in some embodiments of the present invention. At step 823, the hardware device containing the MCIE testing software (residing as firmware on the device) copies the MCIE testing software into system memory. In some embodiments of the present invention, the MCIE testing software may be copied into system memory starting at memory address 0.

From step 825, the copied MCIE testing software takes control of the host system, and begins testing all of the memory space, minus any reserved system windows and the memory addresses where the MCIE testing software itself resides (the very first physical blocks of the system memory), at step 851.

Referring to mapped memory space 830 of FIG. 8a, a layout of DRAM memory space in an embodiment in accordance with the present invention is shown. Total DRAM memory module size 831 is the total memory space of the inserted and detected memory modules. If there is 4 GB of inserted and detected memory modules, then total DRAM module size spans all 4 GB. The total DRAM module size 831 is divided up into: test software shadow 832, legacy block 833, device ROM 835, system ROM 837, data storage 839, other system reserve 841, and video memory system window 843.

Test software shadow 832, as discussed above, is located within the very first blocks of the host system memory, starting at memory address 0. Test software shadow 832, is loaded from the firmware of the memory testing hardware, i.e., memory testing hardware 403 or 409 (which may be a PCI card, or USB device, respectively), at step 823 of flowchart 801. Loading the MCIE testing software into memory accelerates the rigorous testing process. Test software shadow 832, is not tested in the MCIE testing process because doing so would cause the MCIE test software to wipe the memory space in which it resides. While test software shadow 832, may be loaded into blocks of defective memory, testing the software shadow 832, memory location is not necessary, as errors will become apparent when the MCIE test fails to execute properly.

Legacy block 833 is a 640K block of memory originating from the first Intel-based computers, which had only 640K of system memory. New computer systems maintain the 640K legacy block 833 for legacy support, and usually use it for normal storage purposes. Just as other storage portions of the DRAM modules, it can't be assumed that legacy block 833 is manufactured with 100% reliability, and therefore is also tested by the MCIE testing software.

Device ROM 835 and system ROM 837 are reserved memory blocks located at the uppermost region of mapped memory space 830 for ROM, RAM on peripherals, and memory-mapped input/output (I/O, also MMIO). Device ROM 835 and system ROM 837 may also be called the Upper Memory Area (UMA) that lies above the conventional 640K memory partitioned to hold the content of device and system operation instructions. When device ROM 835 and system ROM 837 are overwritten with new data, a portion or all of the original device and system operation instructions are wiped out, causing errors or becoming non-functional. During the MCIE tests, device ROM 835 and system ROM 837 are avoided.

Data storage 839 is the region of mapped memory space 830 used for traditional RAM functions. This space is freely readable/writable without causing any system conflicts. Data storage 839 is an exemplary region for which the MCIE testing software was designed to test.

Other system reserve 841 and video memory system window 843 comprise the system windows created at step 819. Other system reserve 841's addresses are used for system devices such as, for example, local area network (LAN), modem, and audio ports. Video memory system window 843 may be created when a separate graphic card is not present, and the host motherboard's on-board graphic capabilities need to be used. Addresses within other system reserve 841 and video memory system window 843 are valid DRAM addresses, however, when accessed, rather than accessing blocks of DRAM memory, the above I/O devices are accessed. Reading and writing to systems windows is not desirable during the testing process, as this would result in testing non-storage locations and possible address errors

From the mapped memory space 830, then, the MCIE testing software, in accordance with an embodiment of the present invention, will only test the integrity of the DRAM cells within legacy block 833 and data storage 839. Test software shadow 832, ROMs 835 and 837, other system reserve 841, and video memory system window 843 are mapped as system windows at previous described step 819, and the MCIE testing software will not read or write to these locations.

Referring now to FIG. 8b, the steps of a host system executing a memory cell integrity emulation test are shown in flowchart 850, in accordance with an embodiment of the present invention. At step 851, the test firmware now has control of the system (from step 825 of flowchart 801), and begins the testing process.

First, at step 853, the bit-mode for the test is chosen, as well as a corresponding system window. For the remainder of flowchart 850, and the discussion below, the mode is set to 32-bits for exemplary purposes. When operating in 32-bit mode, 32 bits of data are read from the jumped-to memory locations, and 32 bits are written to the jumped-to memory locations at a time. Once the bit-mode and system windows are set, the MCIE test proceeds to step 855.

At step 855, the MCIE test determines where it will jump to next. In order to determine the next address to jump to, the test branches to the jump direction calculation steps of FIG. 6b or 6c, for example. When calculating the next jump address at step 855, the jump calculation enters flowchart 610 or flowchart 650 at step 611 when step 853 precedes step 855.

From step 855, the MCIE test may enter flowcharts 610 or 650 at steps 611 or 612. Whether the test enters the jump calculation at step 611 or step 612 depends on the jump number. The test enters at 611 for the first jump of each MCIE test (from steps 853 or 868), where the test is going to jump from byte position 0 to the middle address of the DRAM address range. When entered at step 611, the length of the testing range is calculated, the jump counter is set to 0, an upwards direction is assumed, and the current vector is set in steps 613-618, which are discussed above, in reference to FIG. 6b.

Entering the jump calculation flowchart 610 or 650 at step 612 bypasses the steps for calculating the testing range, resetting of the jump counter, assuming a direction, and setting a vector. These steps, steps 613-618, are only necessary for the first jump through a tested memory range, and repeated execution would prevent the MCIE software from successfully testing the DRAM. Entry at step 612 occurs when steps 861 or 875 immediately precede and initiate the jump calculation, i.e., when flowchart 610 or 650 are entered from steps 861 or 875, then flowchart 610 or 650 is entered at step 612.

In sum, at step 855, the next address to jump to is calculated, the address is jumped to, and the jumped-to address location is written to the pattern buffer. At step 857, the MCIE software determines if the jumped-to address is within a reserved system window range. If it is, then the MCIE software proceeds to step 859 to skip the address, increment the counter at step 861, and re-enter step 855 to determine a new address to jump to. When executing step 855 from step 861, flowcharts 610 or 650 will always enter at step 612.

If, however, at step 857, the test software determines that a system window was not hit, then the test proceeds to step 865.

At step 865, the MCIE software reads 32-bits (in 32-bit mode) from the jumped-to address location, XORs the read content with the byte address, and then writes the result of the XOR operation back to the byte address. When starting with completely zeroed DRAM, this operation will completely write the byte address with 1s.

From step 865, the MCIE test determines if with the previous jump the memory range has been completely tested at step 867. The MCIE testing software subtracts the untested system window ranges from the total memory range to determine how many jumps, in total, will be taken to cover the entire tested memory range. At step 867, if the previous jump did not reach the memory size, then the jump counter is incremented at step 861, and the jump calculation flowchart is reentered from step 855. Again, the MCIE testing software will jump to a new address, verify the jumped-to address is not within a system window, and then XOR the content with the address, writing all 1s.

When, at step 867, the jump number has reached the memory size, this above loop is exited. At this point, the entire testable memory range now contains is, written 32-bits at a time. From step 867, the counter is reset at step 868.

At step 869 the next jump address is calculated and jumped to via the steps of flowchart 810 or 850. At step 871, it is determined whether the jumped-to address is within reserved system window range. If so, then the address is skipped at step 873, the counter is incremented at step 875, and a new address is calculated and jumped to at step 869. When entering step 869 from step 868, flowchart 810 or 850 is entered at step 611; and when entering step 869 from step 875, flowchart 810 or 850 is entered at step 612.

If, at step 871, it is instead determined that the jumped-to address is not within reserved system window range, then at step 879 the MCIE testing software reads the 32 bits of data from the byte address location, XORs the read contents with the byte address, and then writes the results back to the byte address location. In a defect-free and properly functioning memory module, steps 853-867 have completely filled the DRAM with 1s. At step 879, then, XORing an address with its contents (1s) will return the contents of each address to all 0s.

At step 881, the MCIE test determines whether the previous jump reached the memory size. If not, then the loop executes again, until the contents of each address have been returned to 0s. Once the memory size has been reached at step 881, the MCIE test software reviews stored values of the memory cells within the tested memory range. If all memory cells within the tested memory range are now 0, then the MCIE test has executed successfully at step 885, and the DRAM is very likely defect-free. If, however, at step 883, not all addresses are 0, then the test fails at step 867, and there are defective DRAM chips. As discussed above, in reference to FIG. 7, identifying the address where the blocks are not 0 will also identify the defective DRAM chip, facilitating quick replacement, and reinsertion into the manufacturing, testing, and shipping flow.

Although the present invention has been described in terms of specific embodiment, it is anticipated that alterations and modifications thereof will no doubt become apparent to those more skilled in the art. It is therefore intended that the following claims be interpreted as covering all such alterations and modification as fall within the true spirit and scope of the invention.

What is claimed is:

1. A method of testing memory modules having addressable memory blocks comprising:
starting testing at byte position 0 of the memory modules;
jumping through at least a selected set of the memory modules' range of addressable memory blocks a first time, and writing 1s to each of said selected addressable memory blocks;
returning to byte position 0 of the memory module; and
jumping through the selected memory modules' range of addressable memory blocks a second time, and writing 0s to each of said selected addressable memory blocks.

2. The method of testing memory modules of claim 1, wherein testing of the memory addresses set aside for system windows, or test software shadow in the addressable memory is avoided.

3. The method of testing memory modules of claim 2, wherein the writing of 1s to each of said addressable memory blocks is caused by XORing the jumped-to address with the jumped-to addresses contents.

4. The method of testing memory modules of claim 3, wherein the writing of 0s to each of said addressable memory blocks is caused by XORing the jumped-to address with the jumped-to addresses contents.

5. The method of testing memory modules of claim 4, further checking the range of addressable memory blocks for all 0 values after jumping through the memory modules' range of addressable memory blocks a second time, and writing 0s to each of said addressable memory blocks.

6. The method of testing memory modules of claim 5, further noting any addressable memory blocks not having 0 values as defective after checking the range of the range of addressable memory blocks for all 0 values.

7. The method of testing memory modules of claim 6, further determining the direction for each jump of jumping through the memory modules' range of addressable memory blocks a first time, and for each jump of jumping through the memory modules' range of addressable memory blocks a second time by:
retrieving the address of the previous jumped-to address; and
XORing the last two bits of the previous jumped-to address with each other, and then XORing this result with a bit representation of the previous jump direction.

8. The method of testing memory modules of claim 7, further representing the previous jump direction with a first bit value if the previous jump direction was upwards, and representing the previous jump direction with a second bit value if the previous jump direction was downwards.

9. The method of testing memory modules of claim 8, further determining the direction of the next jump direction as upwards if the result of XORing the last two bits of the previous jumped-to address with each other, and then XORing this result with the bit representation of the previous jump direction is a first bit value; and determining the direction of the next jump direction as downwards if the result of XORing the last two bits of the previous jumped-to address with each other, and then XORing this result with the bit representation of the previous jump direction is a second bit value.

10. The method of testing memory modules of claim 8, further determining the direction of the next jump direction as the same as the previous jump direction if the result of XORing the last two bits of the previous jumped-to address with each other, and then XORing this result with the bit representation of the previous jump direction is a first bit value; and determining the direction of the next jump direction as the opposite of the previous jump direction if the result of XORing the last two bits of the previous jumped-to address with each other, and then XORing this result with the bit representation of the previous jump direction is a second bit value.

11. An apparatus for testing memory modules comprising:
a motherboard;
a central processing unit (CPU);
a basic input/output system (BIOS);
memory module sockets;
wherein the CPU, BIOS, and memory module sockets are coupled to the motherboard, and the memory module sockets have memory modules inserted therein and wherein upon power on:
checking and verifying all inserted memory as being the same;
summing the total length of all memory modules;
detecting dual channel or single channel access of the memory modules;
creating system windows within the memory length;
copying test firmware into system memory; and
transferring control of the system to said test software in system memory.

12. The apparatus for testing memory modules of claim 11, wherein after transferring control of the system to the test software:
the test software jumps through the memory modules' range of addressable memory blocks a first time, avoiding any system windows, and writing 1s to each jumped-to address;
the test software jumps through the memory modules' range of addressable memory blocks a second time, avoiding any system windows, and writing 0s to each jumped-to address; and
verifies that all jumped-to addresses contain 0s.

13. The apparatus for testing memory modules of claim 14, wherein the test software, when jumping through the memory modules' range of addressable memory blocks a first time, avoiding any system windows, and writing 1s to each jumped-to address, and when jumping through the memory modules' range of addressable memory blocks a second time, avoiding any system windows, and writing 0s to each jumped-to address, determines the direction of each jump by XORing the last two bits of the previous jumped-to address with each other, and then XORing the result with a bit representation of the previous jump direction.

14. The apparatus for testing memory modules of claim 13, wherein the test software bit representation of the direction of the previous jump is a first bit value when the previous jump direction was upwards; and the test software bit representation of the direction of the previous jump is a second bit value when the previous jump direction was downwards.

15. The apparatus for testing memory modules of claim 14, wherein the test software determines the direction of each jump
as being upwards, when the last two bits of the previous jumped-to address are XORed with each other, and the result is XORed with a bit representation of the previous jump, and the result is a first bit value; and
as being downwards, when the last two bits of the previous jumped-to address are XORed with each other, and the result is XORed with a bit representation of the previous jump, and result is a second bit value.

16. The apparatus for testing memory modules of claim 15, wherein the test software determines the direction of each jump
as being the same direction as the previous jump, when the last two bits of the previous jumped-to address are XORed with each other, and the result is XORed with a bit representation of the previous jump, and the result is a first bit value; and
as being the opposite direction of the previous jump, when the last two bits of the previous jumped-to address are XORed with each other, and the result is XORed with a bit representation of the previous jump, and result is a second bit value.

17. The apparatus for testing memory modules of claim 16, wherein the test software writes 1s to each jumped-to address, when jumping through the range of addressable memory blocks a first time, avoiding any system windows, by XORing the jumped-to memory address with the jumped-to memory addresses contents.

18. The apparatus for testing memory modules of claim 17, wherein the test software writes 0s to each jumped-to address, when jumping through the range of addressable memory blocks a second time, avoiding any system windows, by XORing the jumped-to memory address with the jumped-to memory addresses contents.

19. The apparatus for testing memory modules of claim 18, wherein the test software writes 1s to each jumped-to address, when jumping through the range of addressable memory blocks a first time, avoiding any system windows, by XORing the jumped-to memory address with the jumped-to memory addresses contents.

20. The apparatus for testing memory modules of claim 19, wherein the test software writes 0s to each jumped-to address, when jumping through the range of addressable memory blocks a second time, avoiding any system windows, by XORing the jumped-to memory address with the jumped-to memory addresses contents.

21. A method of manufacturing memory modules comprising:
BOM preparation;
first surface, surface mount technology (SMT) processing;
second surface, SMT processing;
basic electrical continuity testing; and
personal computer (PC) motherboard testing including memory cell integrity emulation testing.
